(19) United States
(12) Patent Application Publication
(10) Pub. No.: US 2020/0259171 A1
(43) Pub. Date: Aug. 13, 2020

(54) LITHIUM-ION RECHARGEABLE BATTERY, MULTILAYER STRUCTURE FOR LITHIUM-ION RECHARGEABLE BATTERY, AND METHOD FOR MANUFACTURING LITHIUM-ION RECHARGEABLE BATTERY

(71) Applicant: SHOWA DENKO K.K., Tokyo (JP)

(72) Inventors: Haruaki UCHIDA, Ichihara-shi, Chiba (JP); Akira SAKAWAKI, Ichihara-shi, Chiba (JP); Takaki YASUDA, Ichihara-shi, Chiba (JP)

(73) Assignee: SHOWA DENKO K.K., Tokyo (JP)

(21) Appl. No.: 16/639,211

(22) PCT Filed: Aug. 22, 2018
(86) PCT No.: PCT/JP2018/030917

§ 371 Date: Feb. 14, 2020

(30) Foreign Application Priority Data
Nov. 24, 2017 (JP) 2017-226283

(51) Int. Cl. H01M 4/36; H01M 10/0525; H01M 4/1395; H01M 4/04; H01M 10/44; H01M 4/134; H01M 4/62; H01M 4/38; H01M 10/0585

(52) U.S. Cl. CPC H01M 4/366; H01M 10/0525; H01M 4/1395; H01M 4/0447; H01M 2004/021; H01M 4/134; H01M 4/62; H01M 4/382; H01M 10/0585; H01M 10/446

(57) ABSTRACT

A lithium-ion rechargeable battery (1) includes: a positive electrode layer (20) containing a positive electrode active material; a solid electrolyte layer (30) containing an inorganic solid electrolyte having lithium ion conductivity; and a negative electrode collector layer (50) serving as a negative electrode. The negative electrode collector layer (50) includes: a storage layer (51) containing multiple columnar crystals made of metal titanium and each extending in a thickness direction; and a coating layer (52) coating the storage layer (51). By a charging operation of the lithium-ion rechargeable battery (1), a negative electrode (40) made of metal lithium is formed at grain boundaries inside the storage layer (51). This prevents peeling inside the all-solid lithium-ion rechargeable battery.

### TECHNICAL FIELD

The present invention relates to a lithium-ion rechargeable battery, a multilayer structure for a lithium-ion rechargeable battery, and a method for manufacturing a lithium-ion rechargeable battery.

### BACKGROUND ART

With widespread use of portable electronics, such as mobile phones and laptop computers, a strong need exists for small and lightweight rechargeable batteries with a high energy density. Known examples of the rechargeable batteries meeting such a need include lithium-ion rechargeable batteries. The lithium-ion rechargeable battery includes a positive electrode containing a positive electrode active material, a negative electrode containing a negative electrode active material, and an electrolyte having lithium ion conductivity and disposed between the positive electrode and the negative electrode.

Conventional lithium-ion rechargeable batteries have used an organic electrolyte solution and the like as an electrolyte. Meanwhile, use has been proposed of a solid electrolyte made of an inorganic material (inorganic solid electrolyte) as an electrolyte, and use has also been proposed of a lithium excess layer excessively containing lithium metal and/or lithium as a negative electrode active material (see Patent Document 1). Patent Document 1 discloses laminating a positive electrode collector film, a positive electrode active material film, a solid electrolyte film, and a negative electrode collector film in this order and then producing a lithium excess layer between the solid electrolyte film and the negative electrode collector film by charging through the positive electrode collector film and the negative electrode collector film.

### CITATION LIST

### Patent Literature

Patent Document 1: Japanese Patent Application Laid-Open

Publication No. 2013-164971

### SUMMARY OF INVENTION

### Technical Problem

Producing a lithium excess layer between a solid electrolyte film and a negative electrode collector film by charging has a drawback in that peeling may occur between the solid electrolyte film and the negative electrode collector film due to formation and disappearance of the lithium excess layer and, as a result, charge/discharge cycle life may shorten.

An object of the present invention is to prevent peeling inside an all-solid lithium-ion rechargeable battery.

### Solution to Problem

According to a first aspect of the present invention, there is provided a lithium-ion rechargeable battery including: a solid electrolyte layer containing an inorganic solid electrolyte having lithium ion conductivity; a titanium layer containing plural columnar crystals made of metal titanium and each extending in a thickness direction; and a negative electrode containing metal lithium stored inside the titanium layer as a negative electrode active material.

According to a second aspect of the present invention, there is provided a multilayer structure for a lithium-ion rechargeable battery, the multilayer structure including, in the following order mentioned: a solid electrolyte layer containing an inorganic solid electrolyte having lithium ion conductivity; and a titanium layer containing plural columnar crystals made of metal titanium and each extending in a thickness direction.

According to a third aspect of the present invention, there is provided a method for manufacturing a lithium-ion rechargeable battery, the method including: forming a positive electrode layer containing a positive electrode active material; forming a solid electrolyte layer on the positive electrode layer, the solid electrolyte layer containing an inorganic solid electrolyte having lithium ion conductivity; and forming a titanium layer on the solid electrolyte layer, the titanium layer containing plural columnar crystals made of metal titanium and each extending in a thickness direction.

The above method may further include, after forming the titanium layer, forming a negative electrode inside the titanium layer by charging a laminate of the positive electrode layer, the solid electrolyte layer and the titanium layer, the negative electrode containing metal lithium as a negative electrode active material.

### Advantageous Effects of Invention

The present invention can prevent peeling inside an all-solid lithium-ion rechargeable battery.

### BRIEF DESCRIPTION OF DRAWINGS

FIGS. 1A and 1B show sectional structures of a lithium-ion rechargeable battery of the present embodiment. FIG. 1A shows a sectional structure immediately after films are deposited. FIG. 1B shows a sectional structure after an initial charge.

FIG. 2 is a flowchart of a method for manufacturing the lithium-ion rechargeable battery.

FIG. 3 shows a cross-sectional STEM picture of an exemplary configuration of the lithium-ion rechargeable battery of the present embodiment immediately after the film deposition.

### DESCRIPTION OF EMBODIMENTS

Embodiments of the present invention will be described in detail below with reference to the attached drawings. In the drawings as referred to in the below description, dimensions of each component, including size and thickness, may differ from actual ones.

### [Configuration of the Lithium-Ion Rechargeable Battery]

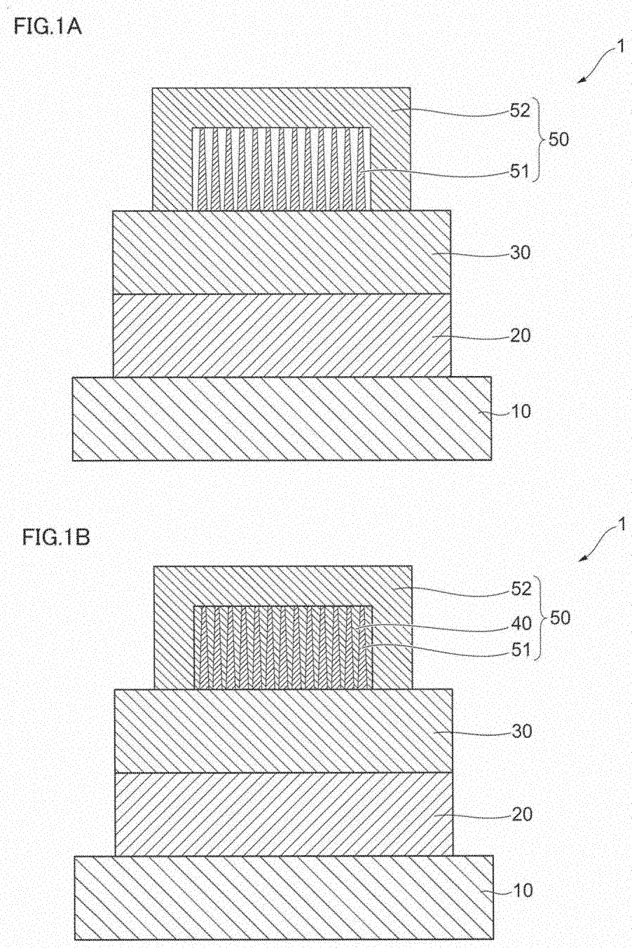

FIGS. 1A and 1B show sectional structures of a lithium-ion rechargeable battery 1 of the present embodiment. As described later, the lithium-ion rechargeable battery 1 of the present embodiment has a multilayer structure composed of multiple layers (films); its basic structure is formed by a so-called deposition process, and the structure is completed by the first (initial) charging operation. FIG. 1A shows a sectional structure immediately after films are deposited. FIG. 1B shows a sectional structure after the initial charge.

(Configuration of the Lithium-Ion Rechargeable Battery Immediately after the Film Deposition)

As shown in FIG. 1A, the lithium-ion rechargeable battery 1 immediately after the film deposition includes: a substrate 10; a positive electrode layer 20 laminated on the substrate 10; a solid electrolyte layer 30 laminated on the positive electrode layer 20; and a negative electrode collector layer 50 laminated on the solid electrolyte layer 30. The negative electrode collector layer 50 includes: a storage layer 51 laminated on the solid electrolyte layer 30; and a coating layer 52 laminated on the storage layer 51 and also directly laminated on the solid electrolyte layer 30 around the periphery of the storage layer 51 to coat the solid electrolyte layer 30 and the storage layer 51.

(Configuration of the Lithium-Ion Rechargeable Battery after the Initial Charge)

As shown in FIG. 1B, the basic configuration of the lithium-ion rechargeable battery 1 after the initial charge is almost the same as that of the lithium-ion rechargeable battery 1 immediately after the film deposition, and difference lies in that, after the initial charge, a negative electrode 40 is formed inside the storage layer 51.

The above constituents of the lithium-ion rechargeable battery 1 will be described in more detail below.

### (Substrate)

The substrate 10 is not limited to a particular material, and may be made of any of various materials including metal, glass, and ceramics.

In the exemplary embodiment, the substrate 10 is composed of a metal plate having electronic conductivity to serve also as a positive electrode collector layer in the lithium-ion rechargeable battery 1. More specifically, in the exemplary embodiment, stainless steel foil (plate), which has higher mechanical strength than copper, aluminum and the like, is used as the substrate 10. Alternatively, metallic foil obtained by plating with conductive metals, such as tin, copper, chrome and the like, may be used as the substrate 10. When an insulating material is used as the substrate 10, a positive electrode collector layer having electronic conductivity may be disposed between the substrate 10 and the positive electrode layer 20.

The substrate 10 may have a thickness of 20 μm or more and 2000 μm or less, for example. With a thickness of less than 20 μm, a pinhole or breaking is likely to occur during rolling in manufacturing the metallic foil or during heat sealing, and additionally, such a thickness leads to increased electrical resistance when the substrate 10 is used as a positive electrode collector layer. Meanwhile, a thickness of more than 2000 μm leads to reduced volume energy density and weight energy density due to increase in battery weight and thickness.

### (Positive Electrode Layer)

The positive electrode layer 20 is a solid thin film and contains a positive electrode active material that releases lithium ions during a charge and occludes lithium ions during a discharge. The positive electrode active material constituting the positive electrode layer 20 may be any of various materials such as oxides, sulfides or phosphorus oxides containing at least one kind of metals selected from manganese (Mn), cobalt (Co), nickel (Ni), iron (Fe), molybdenum (Mo), and vanadium (V). Alternatively, the positive electrode layer 20 may be made of a positive electrode mixture containing a solid electrolyte.

The positive electrode layer 20 may have a thickness of 10 nm or more and 40 μm or less, for example. With the positive electrode layer 20 having a thickness of less than 10 nm, the lithium-ion rechargeable battery 1 obtained therefrom has a too small capacity, which makes the lithium-ion rechargeable battery 1 impracticable. Meanwhile, with the positive electrode layer 20 having a thickness of more than 40 μm, it takes too much time to form the layer, which reduces productivity. The positive electrode layer 20 may, however, have a thickness of more than 40 μm when a large battery capacity is required of the lithium-ion rechargeable battery 1.

While any known deposition method may be used to fabricate the positive electrode layer 20, such as various physical vapor deposition (PVD) and chemical vapor deposition (CVD) methods, it is preferable to use a sputtering method in terms of production efficiency.

### (Solid Electrolyte Layer)

The solid electrolyte layer 30 is a solid thin film and contains a solid electrolyte made of an inorganic material (inorganic solid electrolyte). The inorganic solid electrolyte constituting the solid electrolyte layer 30 is not limited to a particular material as long as the inorganic solid electrolyte has lithium ion conductivity, and may be made of any of various materials including oxides, nitrides, and sulfides.

The solid electrolyte layer 30 may have a thickness of 10 nm or more and 10 μm or less, for example. With the solid electrolyte layer 30 having a thickness of less than 10 nm, the lithium-ion rechargeable battery 1 obtained therefrom is prone to a short circuit (leakage) between the positive electrode layer 20 and the negative electrode collector layer 50 (more specifically the negative electrode 40). Meanwhile, when the solid electrolyte layer 30 has a thickness of more than 10 μm, it increases internal resistance of the battery, which is disadvantageous for high speed charging/discharging.

While any known deposition method may be used to manufacture the solid electrolyte layer 30, such as various PVD and CVD methods, it is preferable to use a sputtering method in terms of production efficiency.

### (Negative Electrode)

The negative electrode 40 contains a negative electrode active material that occludes lithium ions during a charge and releases lithium ions during a discharge. As described above, the negative electrode 40 of the present embodiment is formed inside the storage layer 51 by a charging operation. In the present embodiment, metal lithium itself functions as a negative electrode active material.

A preferred method for manufacturing the negative electrode 40 is to form (deposit) the negative electrode 40 by charging, as described later.

### (Negative Electrode Collector Layer)

The negative electrode collector layer 50 is a solid thin film, and both of the storage layer 51 and the coating layer 52 are made of a metal material having electronic conductivity.

The negative electrode collector layer 50 as a whole may have a thickness of 20 nm or more and 80 μm or less, for example. With a thickness of less than 20 nm, the negative electrode collector layer 50 lacks sufficient capacity to store lithium. Meanwhile, when the negative electrode collector layer 50 has a thickness of more than 80 μm, it increases internal resistance of the battery, which is disadvantageous for high speed charging/discharging.

### (Storage Layer)

The storage layer 51, which is an example of the titanium layer, is a solid thin film and has a function to store lithium ions.

The storage layer 51 of the present embodiment has a structure in which multiple columnar crystals made of metal titanium (Ti) each extending in a thickness direction are arranged side by side. In the storage layer 51, lithium ions are stored at a boundary between each two adjacent columnar crystals, or a so-called crystal grain boundary. Note that columnar crystals of titanium constituting the storage layer 51 are typically hexagonal columnar crystals.

The storage layer 51 may have a thickness of 10 nm or more and 40 μm or less, for example. With a thickness of less than 10 nm, the storage layer 51 lacks sufficient capacity to store lithium. Meanwhile, when the storage layer 51 has a thickness of more than 40 μm, it increases internal resistance of the battery, which is disadvantageous for high speed charging/discharging.

While any known deposition method may be used to manufacture the storage layer 51, such as various PVD and CVD methods, it is preferable to use a sputtering method in terms of production efficiency.

### (Coating Layer)

The coating layer 52 is a solid thin film and covers a top and sides of the storage layer 51 to thereby coat the storage layer 51 in such a manner that the storage layer 51 is interposed between the coating layer 52 and the solid electrolyte layer 30.

The coating layer 52 of the present embodiment may be made of a material having lower lithium solubility than titanium constituting the storage layer 51. Examples of such a material include aluminum (Al) and tungsten (W), and a material containing at least one kind of these materials may be used. Alternatively, the coating layer 52 may be composed of a laminate of multiple layers made of different materials.

The coating layer 52 may have a thickness of 10 nm or more and 40 μm or less, for example. With a thickness of less than 10 nm, the coating layer 52 may permit leakage of lithium ions having passed through the storage layer 51 from the solid electrolyte layer 30 side. Meanwhile, when the coating layer 52 has a thickness of more than 40 μm, it increases internal resistance of the battery, which is disadvantageous for high speed charging/discharging.

While any known deposition method may be used to manufacture the coating layer 52, such as various PVD and CVD methods, it is preferable to use a sputtering method in terms of production efficiency.

### [Method for Manufacturing the Lithium-Ion Rechargeable Battery]

Below a description will be given of a method for manufacturing the lithium-ion rechargeable battery 1 shown in FIGS. 1A and 1B. As described above, in the present embodiment, the basic structure of the lithium-ion rechargeable battery 1 shown in FIG. 1A is formed by a so-called deposition process, and then the lithium-ion rechargeable battery 1 shown in FIG. 1B is obtained by the first (initial) charging operation.

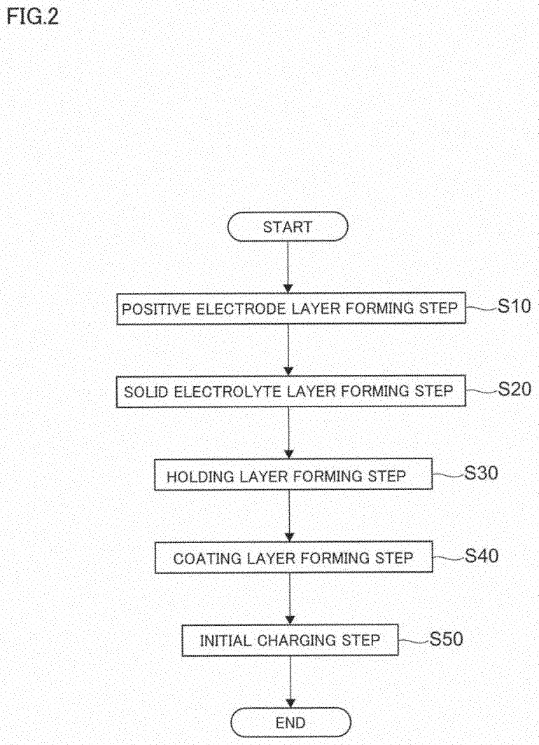

FIG. 2 is a flowchart of the method for manufacturing the lithium-ion rechargeable battery 1.

First, a positive electrode layer forming step is performed where the substrate 10 is mounted on a sputtering device (not shown) to form the positive electrode layer 20 on the substrate 10 (step 10). A solid electrolyte layer forming step is then performed where the solid electrolyte layer 30 is formed on the positive electrode layer 20 by the sputtering device (step 20). Then, a storage layer forming step (an example of the titanium layer forming step) is performed where the storage layer 51 is formed on the solid electrolyte layer 30 by the sputtering device (step 30). Then, a coating layer forming step is performed where the coating layer 52 is formed on the solid electrolyte layer 30 and the storage layer 51 by the sputtering device (step 40). Executing these steps 10 to 40 results in the lithium-ion rechargeable battery 1 immediately after the film deposition as shown in FIG. 1A. This lithium-ion rechargeable battery 1 immediately after the film deposition is removed from the sputtering device.

Then, an initial charging step is performed where the lithium-ion rechargeable battery 1 immediately after the film deposition shown in FIG. 1A is given an initial charge (step 50). This results in lithium being deposited at crystal grain boundaries inside the storage layer 51 of the lithium-ion rechargeable battery 1 immediately after the film deposition shown in FIG. 1A. In other words, the negative electrode 40 made of lithium is formed inside the storage layer 51, resulting in the lithium-ion rechargeable battery 1 after the initial charge as shown in FIG. 1B. The initial charging operation of the lithium-ion rechargeable battery 1 will be detailed later.

### [Exemplary Configuration of the Lithium-Ion Rechargeable Battery]

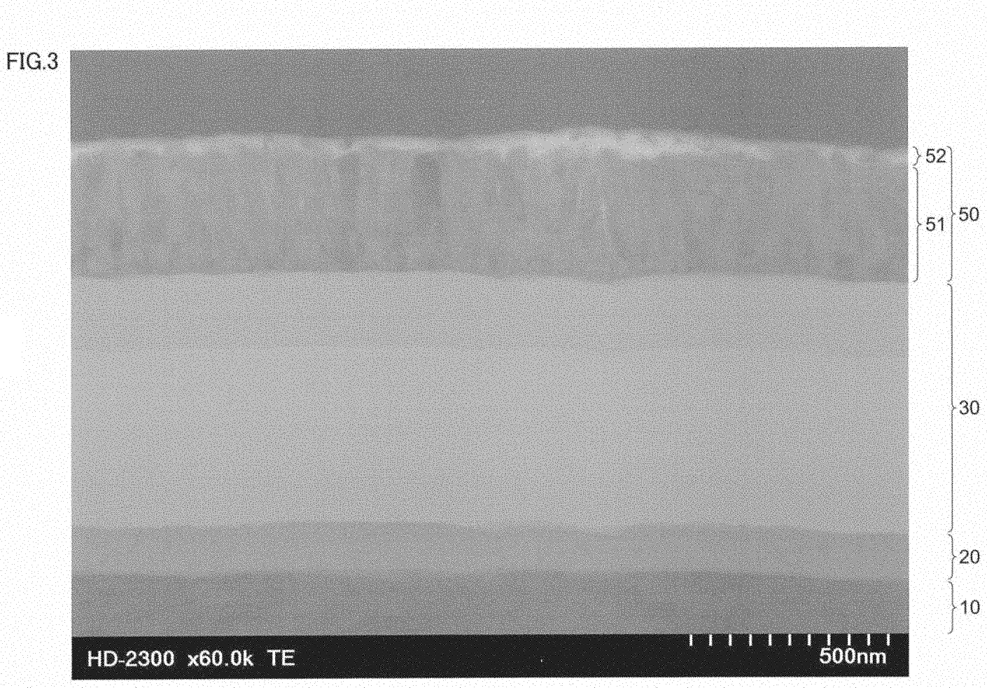

FIG. 3 shows a cross-sectional STEM picture of an exemplary configuration of the lithium-ion rechargeable battery of the present embodiment immediately after the film deposition. This STEM picture was taken by Ultra-thin Film Evaluation System HD-2300 from Hitachi High-Technologies Corporation. The lithium-ion rechargeable battery 1 shown in FIG. 3 does not include the negative electrode 40 because this picture was taken immediately after the films were deposited as shown in FIG. 1A. In FIG. 3, an area above the coating layer 52 appears black; this is because tungsten (W) attached to each sample in taking the STEM picture is seen here.

The specific configuration and manufacturing method of the lithium-ion rechargeable battery 1 shown in FIG. 3 are as follows.

SUS304 was used as the substrate 10. The size of the substrate 10 was 50 mm×50 mm square and 30 μm thick.

Lithium manganate (Li_{1.5}Mn₂O₄) formed by sputtering was used as the positive electrode layer 20. The size of the positive electrode layer 20 was 10 mm×10 mm square, which was smaller than the substrate 10, and 100 nm thick.

LiPON (obtained by displacing a part of oxygen in lithium phosphate (Li₃PO₄) with nitrogen) formed by sputtering was used as the solid electrolyte layer 30. The size of the solid electrolyte layer 30 was 10 mm×10 mm square, which was the same as the positive electrode layer 20, and 600 nm thick.

Titanium formed by sputtering was used as the storage layer 51. The size of the storage layer 51 was 8 mm×8 mm square, which was smaller than the solid electrolyte layer 30, and 300 nm thick.

Aluminum formed by sputtering was used as the coating layer 52. The size of the coating layer 52 was 8 mm×8 mm square, which was the same as the storage layer 51, and 50 nm thick.

FIG. 3 shows that multiple titanium columnar crystals grow in the thickness direction in the storage layer 51 disposed on the solid electrolyte layer 30. FIG. 3 also shows that the coating layer 52 disposed on the storage layer 51 does not have a columnar crystal structure, unlike the storage layer 51.

### [Operation of the Lithium Ion Battery]

When the lithium-ion rechargeable battery 1 in a discharged state is charged, a positive electrode of a DC power source is connected to the substrate 10 functioning as a positive electrode collector layer, and a negative electrode of the DC power source is connected to the coating layer 52 on the outermost side of the negative electrode collector layer 50. Then, lithium ions constituting the positive electrode active material in the positive electrode layer 20 move through the solid electrolyte layer 30 to the negative electrode collector layer 50. In other words, in a charging operation, lithium ions move in the thickness direction of the lithium-ion rechargeable battery 1 (in the upward direction in FIGS. 1A and 1B).

At this time, lithium ions having moved from the positive electrode layer 20 toward the negative electrode collector layer 50 reaches the boundary between the solid electrolyte layer 30 and the storage layer 51 of the negative electrode collector layer 50. The storage layer 51 includes multiple columnar crystals made of metal titanium and extending in the thickness direction. These columnar crystals are arranged side by side. Thus, lithium ions having reached the boundary between the solid electrolyte layer 30 and the storage layer 51 enter the grain boundary between each two adjacent columnar crystals and move further in the thickness direction to get held within the storage layer 51.

Some of lithium ions having entered the storage layer 51 go therethrough to reach the boundary between the storage layer 51 and the coating layer 52. The coating layer 52 is made of a material (e.g., aluminum) having lower lithium solubility than metal titanium constituting the storage layer 51. For this reason, lithium ions having reached the boundary between the storage layer 51 and the coating layer 52 are less likely to enter the coating layer 52, and they remain stored within the storage layer 51.

After the charging operation is finished, lithium ions having moved from the positive electrode layer 20 to the negative electrode collector layer 50 are stored at the grain boundaries inside the storage layer 51 of the negative electrode collector layer 50, where the lithium ions constitute the negative electrode 40.

When the lithium-ion rechargeable battery 1 in a charged state is discharged (used), a positive side of a load is connected to the substrate 10 and a negative side of the load is connected to the coating layer 52. Then, lithium ions contained in the negative electrode 40 inside the storage layer 51 of the negative electrode collector layer 50 move in the thickness direction (in the downward direction in FIGS. 1A and 1B) through the solid electrolyte layer 30 to the positive electrode layer 20, where the lithium ions constitute the positive electrode active material. Along with this, a direct current is supplied to the load.

After the discharge operation is finished, the negative electrode 40 inside the storage layer 51 does not disappear but remain because of some lithium that does not move during the discharging operation.

### Conclusion

As described above, the lithium-ion rechargeable battery 1 of the present embodiment includes the storage layer 51 in a portion of the negative electrode collector layer 50 facing the positive electrode layer 20 across the solid electrolyte layer 30. The storage layer 51 is composed of multiple arranged columnar crystals made of metal titanium and extending in the thickness direction. This allows the storage layer 51 to accommodate the negative electrode 40. This can prevent peeling between the solid electrolyte layer 30 and the negative electrode collector layer 50 due to formation of a layer of the negative electrode 40 made of metal lithium (lithium excess layer) between the solid electrolyte layer 30 and the negative electrode collector layer 50 during a charge, as compared to when the storage layer 51 is not present. This helps lengthen charge/discharge cycle life of the lithium-ion rechargeable battery 1. Moreover, as compared to when the storage layer 51 is not present, the amount of lithium ions that can be stored by the negative electrode 40, namely the capacity of the lithium-ion rechargeable battery 1 increases. Additionally, covering the storage layer 51 with the coating layer 52 helps prevent leakage of lithium to the outside of the lithium-ion rechargeable battery 1.

Generated voltage of the lithium-ion rechargeable battery 1 of the present embodiment is determined by the positive electrode active material constituting the positive electrode layer 20 and the negative electrode active material constituting the negative electrode 40, which is lithium. This means that titanium constituting the storage layer 51 of the negative electrode collector layer 50 has little influence on the generated voltage of the lithium-ion rechargeable battery 1 of the present embodiment.

### [Other Notes]

In the present embodiment, the negative electrode 40 made of metal lithium is formed by charging, but this is by way of example only and not of limitation.

In the present embodiment, the lithium-ion rechargeable battery 1 is described as being a so-called thin-film all-solid-state battery, but this is by way of example only and the lithium-ion rechargeable battery 1 may be a so-called bulk-type solid-state battery. When the lithium-ion rechargeable battery 1 is a bulk-type solid-state battery, any other manufacturing method than the above film deposition method may be used.

### REFERENCE SIGNS LIST

1 Lithium-ion rechargeable battery
10 Substrate
20 Positive electrode layer
30 Solid electrolyte layer
40 Negative electrode
50 Negative electrode collector layer
51 Storage layer
52 Coating layer

1. A lithium-ion rechargeable battery comprising:
a solid electrolyte layer containing an inorganic solid electrolyte having lithium ion conductivity;
a titanium layer containing a plurality of columnar crystals made of metal titanium and each extending in a thickness direction; and
a negative electrode containing metal lithium stored inside the titanium layer as a negative electrode active material.

2. A multilayer structure for a lithium-ion rechargeable battery, the multilayer structure comprising, in the following order mentioned:
a solid electrolyte layer containing an inorganic solid electrolyte having lithium ion conductivity; and
a titanium layer containing a plurality of columnar crystals made of metal titanium and each extending in a thickness direction.

3. A method for manufacturing a lithium-ion rechargeable battery, the method comprising:
forming a positive electrode layer containing a positive electrode active material;
forming a solid electrolyte layer on the positive electrode layer, the solid electrolyte layer containing an inorganic solid electrolyte having lithium ion conductivity; and
forming a titanium layer on the solid electrolyte layer, the titanium layer containing a plurality of columnar crystals made of metal titanium and each extending in a thickness direction.

4. The method for manufacturing a lithium-ion rechargeable battery according to claim 3, further comprising, after forming the titanium layer, forming a negative electrode inside the titanium layer by charging a laminate of the positive electrode layer, the solid electrolyte layer and the titanium layer, the negative electrode containing metal lithium as a negative electrode active material.
